(19) United States
(12) Patent Application Publication
(10) Pub. No.: US 2009/0223062 A1
(43) Pub. Date: Sep. 10, 2009

(54) SIDE LOADING POCKET KNIFE

(76) Inventor: Daniel Tucker, Kearns, UT (US)

Correspondence Address: ADVANTIA LAW GROUP, 9035 SOUTH 1300 EAST, SUITE 200, SANDY, UT, 84094, US

(21) Appl. No.: 12/044,211

(22) Filed: Mar. 7, 2008

(51) Int. Cl. B26B 1/08

(52) U.S. Cl. 30/162

(57) ABSTRACT

A knife, comprising a handle including a blade feed aperture, a thumb aperture, and a cartridge loading aperture disposed through the front, side and back end of the handle. The knife also includes a blade disposed within the handle, wherein the blade may be coated with a non-stick material. The handle also includes a biased member disposed within the handle and configured to bias the blade. The handle may also include a cartridge disposed within the handle and configured to store a plurality of blades. The cartridge includes a safety lock mechanism; wherein the safety lock mechanism is disposed near a front end of the handle and configured to selectably lock a blade in a lateral position. The cartridge may be selectably removable from the handle or the cartridge may be permanently coupled to the handle of the knife.

### BACKGROUND OF THE INVENTION

1. Field of the Invention

The present invention relates to knives, specifically to a side loading pocket knife.

2. Description of the Related Art

Pocket knives are employed for a wide variety of tasks. For example replaceable utility knife blades are used in cutting carpeting, cardboard, dry wall sheets, plastic and other materials. The blades dull quickly and must be replaced often to provide a sharp cutting edge. Replacement blades, having a highly sharpened cutting edge are dangerous to handle. A holder and dispenser which eject a single blade at a time is desirable to both protect the edge of the blades and minimize handling of the blades. A typical utility knife blade is metal, trapezoidal shaped blade with the longest edge the cutting edge and including notches on the shorter back of the blade. Other blade configurations such as single edged blades and utility blades with a hook shaped cutting edge are known.

Typical heavy duty cutter has double sides of the blades in trapezium shape, which is different from the type that the blades connected to one another, if the one in the front is not sharp anymore, user can change to a new one by breaking the old one off from the long connected row of blades. The typical one usually comes in a package with a certain number of blades; user then stores a pile of blades in cartridge of cutter ready for use. Usually, users will dispose used blades instead of putting them back to cartridge, therefore the most common way of sliding out the blade is mainly pushing the sliding block, which sometimes could get stuck and not very smooth.

Some improvements have been made in the field. Examples of references related to the present invention are described below, and the supported teachings of each reference are incorporated by reference herein:

U.S. Pat. No. 2,680,291, issued to Shnitzler et al., discloses a magazine comprising of a channel shaped casing having grooved side walls and a sheet metal cover fitting slideably in the grooves of the side walls and having angular portions at both ends positively locking the cover against movement in either direction longitudinally with respect to the casing. A magazine of this character has the outstanding advantage that it may be constructed essentially of two parts, a casing and a cover, and that these parts may be interlocked in assembled relation without requiring other fastening means.

U.S. Pat. No. 2,567,230, issued to Muros, discloses a blade magazine comprising walls forming an elongated enclosure, a blade locating rib therein, a stack of slotted blades removably held by the rib, and a single blade located above the stack in a longitudinally advanced position, together with a feeding device mounted for reciprocating movement on a wall of the enclosure and having one portion shaped and disposed for engaging and advancing the said displaced blade in the initial movement of the device and another portion shaped and disposed for engaging and advancing the next underlying blade in the concluding movement of the device in the same direction.

U.S. Pat. No. 2,889,076, issued to Van Schie, disclose a razor blade dispensing container comprising of top and bottom walls connected by the side and end walls. The bottom wall defining discharge opening with support shelves at each end thereof and a downwardly and outwardly inclined knife edge at the edge of the front shelf, the end walls defining horizontal slots at the surfaces of the shelves, said slots being of greater thickness than the thickness of one of the blades but less than twice the thickness of one of the blades to be dispensed, vertical guide ribs on said end walls adapted to locate a stack of blades within the container and over the shelves, spring means on the top wall urging the ends of a stack of blades downwardly toward said shelves, a dispensing slide slideably disposed on said shelves and projecting through said slots, said slide being of less thickness than one of the blades to be dispensed and defining a central opening of greater dimension than the blades to be dispensed, a finger piece on the forward end of said slide, spring means disposed to bias said slide forwardly, and a stop on the rear of said slide engageable with the back wall of the container to locate said slide with the opening therein registering with both said shelves.

U.S. Pat. No. 3,850,343, issued to Petrillo, disclose a razor blade magazine including an elongated molded plastic body member having an integral forwardly extending key portion. Formed in the body member are two sets of longitudinally extending flange portions, the upper flange portions defining a slot in which a blade pusher is slidable, and the lower set of flange portions providing a surface for supporting a stack of blade units within the body member. An end plug of molded plastic is received in and closes the transverse opening at the rear end of the body member and includes a horizontal reinforcing web that extends between two side walls of the plug. Formed integrally with and extending forward of one of the side walls is a blade positioning structure that includes four surfaces, the blade positioning structure acting to properly position blades stored in the body member.

U.S. Pat. No. 3,869,066, issued to Ferraro, discloses a safety razor blade dispenser of the type in which the uppermost blade in a stack of blades is adapted to push end-wise into shaving position in a head of an associated razor. The dispenser comprises a molded plastic body having the stack of blades biased upwardly therein and a pusher slidable in a slot formed in the top of the body for engaging the uppermost blade in the stack and pushing it through a blade exit aperture formed in a forward end wall of the body. The pusher has a relatively narrow transverse support portion located forward of a transverse center line of the pusher for sliding engagement with the upper surfaces of the top wall of the body. An end closure member is positioned in an opened rear end of the body, and includes a forwardly extending elongated member for biasing an undersurface of the blade pusher upwardly when the pusher is in a rearmost position in the slot.

U.S. Pat. No. 4,826,042, issued to Vujovich, disclose a holder for blades having a dispensing opening through which a single blade can be slideably ejected by either a sliding ejector or manual manipulation through a thumb slot. The blades within the holder are aligned by a free floating partition which is biased toward the dispensing opening by at least one rubber band formed in a double loop configuration. The double loop configuration orients the rubber band such that it loops around the back of the holder, loops adjacent the front of the holder, and loops around the back of the sliding partition. The ejector includes an extension to occlude the edge of a dispensed blade.

U.S. Pat. No. 4,981,212, issued to Lutz et al., discloses a device for holding knife blades intended for sale, comprising a stiff sheet-like carrier on which there is mechanically mounted a dispenser which receives the blades and protects them from direct access, in such a way that the carrier has to be destroyed in order to open the dispenser and to free it from the carrier.

U.S. Pat. No. 5,251,783, issued to Gringer, discloses a utility blade dispenser for dispensing and disposing utility or razor type blades is disclosed. A disposable transparent thermoplastic housing shaped to correspond with the shape of the utility blade to be dispensed is provided. The housing is hinged to allow the blades and a blade carrier to be inserted in the housing at the time of manufacture, and then be sonically welded. Dispensing and guide slots are provided to guide blades from inside the housing out through the dispensing slot. The blades are supported in the housing on a blade carrier which is upward and downward moveable in the housing. The blade carrier includes a support hole for mounting the dispenser on a wall. The rear of the housing includes a track of ratcheting teeth which engage a pawl member on the rear of the blade carrier to minimize movement between the housing and carrier. As utility blades are used and the blade carrier moved upward, a disposal chamber is formed between the bottom of the blade carrier and the bottom of the housing. A disposal slot and an upward protrusion on the housing bottom allow used blades to be inserted into the disposal chamber, and prevent them from falling outward.

U.S. Pat. No. 6,158,616, issued to Huang, discloses a cutter blade dispenser and disposer with slide biasing means and side located dispensing slot comprising a body, a sliding block and a side compartment. The body is a trapezium case and can room a plurality of blades, an elongate slit rail is disposed on top of the body, inside the body has a pillar for an elastic element to sleeve on, an elastic block is disposed on top of the opening of the body. The sliding block is in trapezium shape for fitting inside the body with an inclined piece and a pressing block disposed on its top. The side compartment is also in trapezium shape and can cover the opening of the body; a locking hole is disposed on top of the side compartment with a sliding hole and an elongate slit on its one side. The sliding hole and the elongate slit are in one through passage. A storage board is disposed underneath the sliding block and inside on the bottom of the body. The storage board has a protrusion bar on its each side for placing the blades in decency and order. A plurality of protruded pieces is disposed on one end of the storage board to limit and stop the sliding block. Accordingly, put the sliding block inside the body and slide it so that the sliding block bounces back out because of the elasticity provided by the elastic element. The storage board is then being pushed outside the opening of the body to a distance; the storage board can be pulled more outside for placing the blades. Thus to achieve the purpose of more convenient and safer storage and disposal of said blades.

U.S. Pat. No. 6,446,802, issued to Lutz et al., discloses a container has an internal cavity for receiving knife blades lying side by side in a stack, the internal cavity being capable of being reduced in size by a slide member which is preferably displaceable in only one direction. In this way the blades are located in position however full the container is, and damage to the cutting edges by movement or slipping in the package is avoided. Furthermore a method is proposed by which first the blade which lies against the slide is extracted from the stack and then the slide member is urged against the stack of blades.

The inventions heretofore known suffer from a number of disadvantages which include being inconvenient, being cumbersome, being effective, being inefficient, being expensive, and being bulky.

What is needed is a side loading pocket knife that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available side loading pocket knives. Accordingly, the present invention has been developed to provide an efficient and effective side loading pocket knife.

A knife may comprise of a handle, wherein the handle may include a blade feed aperture through a front end of the handle. The blade feed aperture may be configured to allow a blade to pass laterally therethrough. The handle may also include a thumb aperture through a side end of the handle. The thumb aperture may be configured to allow a thumb to manipulate the blade therethrough. The handle may further include a cartridge loading aperture through a back end of the handle. The cartridge loading aperture may be configured to allow a cartridge to pass laterally therethrough. The knife may also include a blade disposed within the handle, wherein the blade may be configured to cut material. The handle may also include a bias member disposed within the handle and configured to bias the blade toward the thumb aperture. The bias member may be coupled to an interior side portion of the handle and may extend towards the thumb aperture.

The knife may further include a cartridge disposed within the handle and may be configured to store a plurality of blades. The cartridge may include a safety lock mechanism; wherein the safety lock mechanism may be disposed near a front end of the cartridge and may be configured to selectably lock a blade in a lateral position. In addition the safety lock mechanism may also be configured to secure the cartridge within the handle; wherein the cartridge may be selectably removable from the handle through the cartridge loading aperture. A bias member may be coupled to the interior portion of the cartridge extending towards a thumb aperture. The cartridge may further include a second thumb aperture through a side end of the cartridge and which may be configured to allow a thumb to manipulate therethrough. Finally, the cartridge may include a second blade feed aperture through a front end of the cartridge and which may be configured to allow a blade to pass laterally therethrough. The cartridge may also be permanently coupled to the handle. The blades of the knife may be coated with a non-stick material, on either or both sides of the blade.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not therefore to be considered to be limiting of its scope, the invention will be described and explained with additional specificity and detail through the use of the accompanying drawing(s), in which:

FIG. 1 is a side perspective view of a side loading pocket knife, according to one embodiment of the invention;

FIG. 2 is a side perspective view of a side loading pocket knife, according to one embodiment of the invention;

FIG. 3 is a side perspective view of a side loading pocket knife, according to one embodiment of the invention;

FIG. 4 is a front cross sectional of a blade cartridge of the side loading pocket knife, according to one embodiment of the invention; and

FIG. 5 is a side cross sectional view of a blade cartridge of the side loading pocket knife, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment or example is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

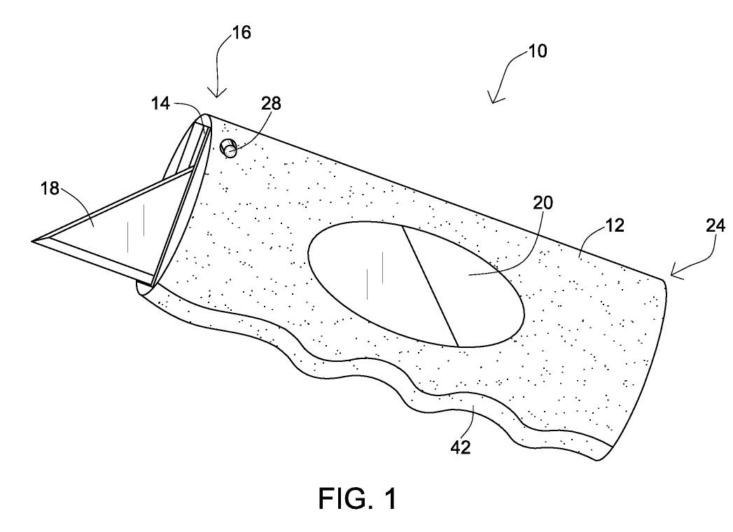

FIG. 1 illustrates a knife 10, according to one embodiment of the invention, comprising a handle 12. The handle 12 includes a blade feed aperture 14 disposed through a front end 16 of the handle 12, wherein the blade feed aperture 14 is configured to allow a blade 18 to pass laterally therethrough. The handle 12 also includes a thumb aperture 20 disposed through one side of the handle 12, wherein the thumb aperture 20 is configured to allow a thumb to manipulate therethrough. The knife 10 also includes a blade 18 disposed with the handle 12, wherein the blade 18 is configured to cut material. The knife 10 further includes a safety lock mechanism 28 disposed near a front end 16 of the handle 12, wherein the safety lock mechanism 28 is configured to selectably lock a blade 18 in a lateral position.

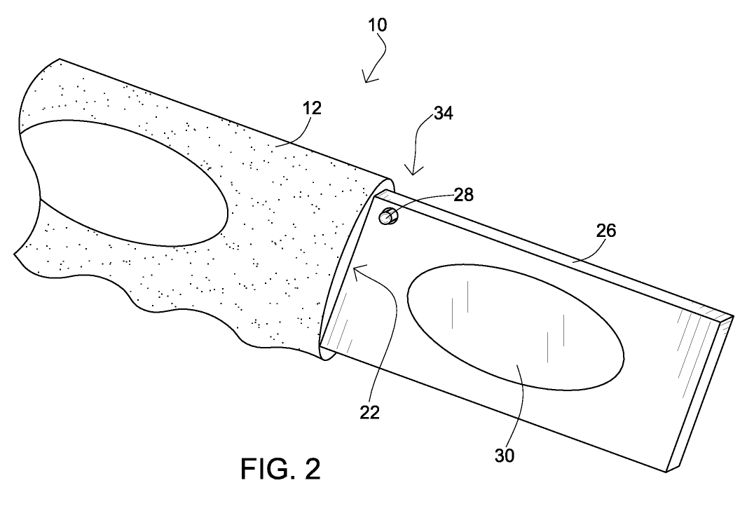

FIG. 2 illustrates a knife 10, according to one embodiment of the invention, comprising a handle 12. The handle 12 includes a cartridge 26 disposed within the handle 12, wherein the cartridge 26 is configured to be selectably removable from the handle 12 through the cartridge loading aperture 22. The cartridge 26 includes a second thumb aperture 30 disposed through one side of the cartridge 26 and configured to allow a thumb to manipulate therethrough. The cartridge 26 further includes a safety lock mechanism 28 disposed near a front end 34 of the cartridge 26 and configured to selectably lock a blade in a lateral position. Moreover, the safety lock mechanism 28 is also configured to selectably lock the cartridge 26 within the handle 12.

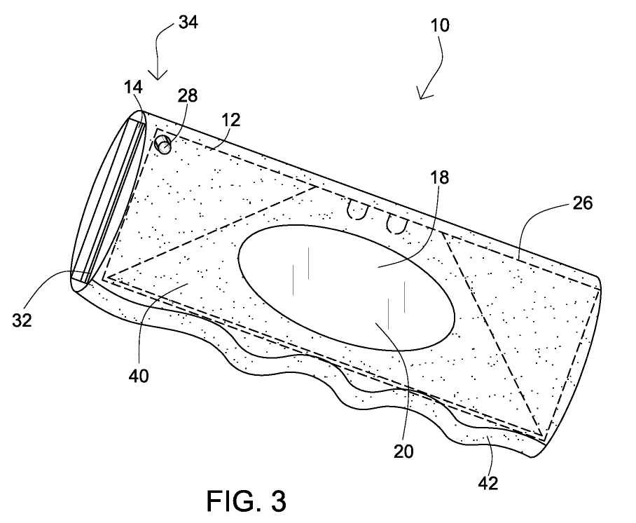

FIG. 3 illustrates a knife 10, according to one embodiment of the invention, comprising of a handle 12. The handle 12 includes a safety lock mechanism 28, wherein the safety lock mechanism 28 is configured to secure a blade 18 in a lateral position. The safety lock mechanism 28 is configured to secure the blade 18 in a lateral position, wherein the blade 18 is not exposed and stored in a safe lateral position 40. The knife 10 also includes a plurality of gripping members 42, wherein the gripping members 42 helps the user firmly grip the knife 10 during use. The knife further includes a cartridge 26 disposed within the handle, wherein the cartridge includes a second blade feed aperture 32 disposed through a front end 34 of the cartridge 26, wherein the second blade feed aperture 32 is configured to allow a blade 18 to pass laterally therethrough.

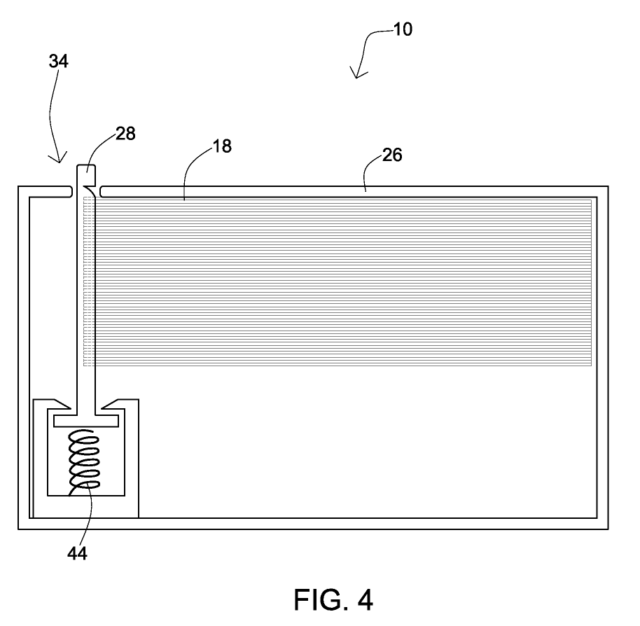

FIG. 4 illustrates a cartridge of a knife 10, according to one embodiment of the invention, comprising a safety lock mechanism 28. The safety lock mechanism 28 is disposed near a front end 34 of the cartridge 26 and configured to selectably lock a blade 18 in a lateral position. The safety lock mechanism 28 includes a spring 44 configured to activate the safety lock mechanism.

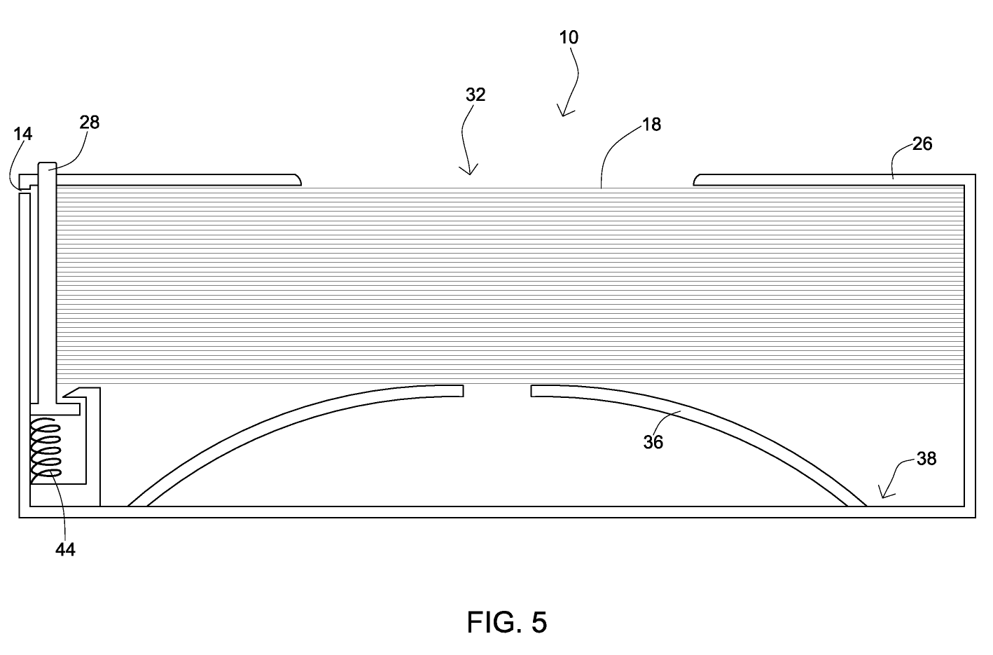

FIG. 5 illustrates a cartridge of a knife 10, according to one embodiment of the invention, comprising of a bias member 36. The bias member 36 is disposed on an interior 38 of the cartridge 26 and is configured to extend toward the second thumb aperture 32. The bias member 36 compresses the blade 18 toward the second thumb aperture 32 to enable a user to manipulate the blade 18 through the second thumb aperture 32. The user engages the safety lock mechanism 28 in order to slide the blade 18 through the blade feed aperture 14 and secures the blade 18 in a lateral position. The cartridge 26 also includes a spring 44

In operation of the knife 10 according to one embodiment, a user picks up the knife 10 and engages the safety lock mechanism 28 and manipulates a blade 18 through the thumb aperture 20 to enable the blade 18 to move forward through the blade feed aperture 14. The safety lock mechanism 28 engages the blade 18 and secures the blade 18 in a lateral position, ready for use. The user may engage the safety lock mechanism 28 again and manipulate the blade 18 back through the blade feed aperture 14 and store the blade 18 within the handle 12 of the knife 10. The safety lock mechanism 28 secures the blade 18 within the handle 12 of the knife 10.

In operation of another embodiment of the invention, a user picks up the knife 10 and engages the safety lock mechanism 28 and slides the cartridge 26 of the handle 12 through the cartridge loading aperture 22. The user may replace the blades within the cartridge 26 or reverse the blades to use the unused side of the blade. The user then slides the cartridge 26 back through the cartridge loading aperture 22 and secures the safety lock mechanism 28 of the cartridge 26 to the handle 12 of the knife 10.

In operation of yet another embodiment of the invention, a user may pick up the knife 10 and engage the safety lock mechanism 28, wherein the safety lock mechanism 28 is disposed on the opposite side of the handle 12 relative to the thumb aperture 20. This configuration enables a user with one hand to engage the safety lock mechanism 28 with the index finger and to manipulate the blade 18 through the thumb aperture 20 with the thumb through the blade feed aperture 14. One skilled in the art would appreciate this one hand configuration, to quickly and easily cut material and then return the blade 18 to the handle 12 of the knife 10.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

For example, although the figures illustrate a cartridge selectably removable, one skilled in the art would appreciate that the cartridge may be permanently coupled to the handle of the knife and still perform its intended function. The knife would therefore become disposable.

Additionally, although the figures illustrate a rectangular cartridge, one skilled in the art would appreciate that the cartridge may vary in size, shape, design, configuration, color, length, width, height, and still perform its intended function.

It is also envisioned that the blades may be coated with a non-slip material, wherein the non-slip material slides effortlessly against each other, but has a high friction coefficient against skin. Thereby enabling the user to manipulate the blade in a firm and secure fashion, and creating a frictionless surface between the blades.

In addition, although the figures illustrate dual bias members, one skilled in the art would appreciate that the bias member may be one single bias member extending substantially the length of the cartridge or handle and still perform its intended function. The bias member may also vary in size, shape, design, configuration, color, length, width, height, and still perform its intended function.

Furthermore, although the figure illustrate a substantially oval thumb aperture, one skilled in the art would appreciate that the thumb aperture may vary in size, shape, design, configuration, length, width, height, orientation, and still perform its intended function.

Moreover, although the figures illustrate a safety lock mechanism including a spring and a protruding member, one skilled in the art would appreciate that the safety lock mechanism may be but not limited to a safety lock mechanism as described in U.S. Pat. No. 5,822,866, issued to Pardue; U.S. Pat. No. 6,591,504, issued to Onion; U.S. Pat. No. 4,601,184, issued to Doinel; U.S. Pat. No. 5,815,927, issued to Collins; and U.S. Pat. No. 6,510,639, issued to McMoore.

It is expected that there could be numerous variations of the design of this invention. An example is that the handle may vary in size, shape, design, configuration, color, length, width, height, and still perform its intended function.

Finally, it is envisioned that the components of the device may be constructed of a variety of materials, such as but not limited to: metal, metal alloys, plastic, rubber, rubber composites, plastic composites, glass, graphite, and still perform its intended function.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A knife, comprising:
a handle including:
a blade feed aperture through a front end of the handle and configured to allow a blade to pass laterally therethrough;
a thumb aperture through a side end of the handle and configured to allow a thumb to manipulate the blade therethrough; and
a cartridge loading aperture through a back end of the handle and configured to allow a cartridge to pass laterally therethrough;
a blade disposed within the handle and configured to cut material;
a biased member disposed within the handle and configured to bias the blade toward the thumb aperture; and
a cartridge disposed within the handle and configured to store a plurality of blades including a safety lock mechanism; wherein the safety lock mechanism is disposed near a front end of the handle and configured to selectably lock a blade in a lateral position.

2. The knife of claim 1, wherein the blade is coated with a non-stick material.

3. The knife of claim 1, wherein the blade is coated on both sides with the non-stick material.

4. The knife of claim 1, wherein the bias member is a strip of elastic material.

5. The knife of claim 4, wherein the bias member is coupled to an interior side portion of the handle and extends towards the thumb aperture.

6. The knife of claim 1, wherein the cartridge is selectably removable from the handle through the cartridge loading aperture; wherein the safety lock mechanism is configured to secure the cartridge within the handle; wherein the cartridge further includes:
a plurality of blades disposed within the cartridge;
a bias member coupled to the interior portion of the cartridge extending towards a thumb aperture;
a second thumb aperture through a side end of the cartridge and configured to allow a thumb to manipulate therethrough; and
a second blade feed aperture through a front end of the cartridge and configured to allow a blade to pass laterally therethrough.

7. The knife of claim 1, wherein the cartridge is permanently coupled to the handle.

8. A knife, comprising:
a handle including:
a blade feed aperture through a front end of the handle and configured to allow a blade to pass laterally therethrough; and
a thumb aperture through a side end of the handle and configured to allow a thumb to manipulate the blade therethrough.
a blade disposed within the handle and configured to cut material;
a biased member disposed within the handle and configured to bias the blade toward the thumb aperture; and
a safety lock mechanism; wherein the safety lock mechanism is disposed near a front end of the handle and configured to selectably lock a blade in a lateral position.

9. The knife of claim 8, wherein the blade is coated with a non-stick material.

10. The knife of claim 8, wherein the blade is coated on both sides with the non-stick material.

11. The knife of claim 8, wherein the bias member is a strip of elastic material.

12. The knife of claim 11, wherein the bias member is coupled to an interior side portion of the handle and extends towards the thumb aperture.

13. A utility knife, configured to readily provide a plurality of blades, comprising:
a handle including:
a blade feed aperture through a front end of the handle and configured to allow a blade to pass laterally therethrough;
a thumb aperture through a side end of the handle and configured to allow a thumb to manipulate the blade therethrough; and
a cartridge loading aperture through a back end of the handle and configured to allow a cartridge to pass laterally therethrough;
a blade disposed within the handle and configured to cut material; wherein the blade is coated with a non-stick material; wherein the blade is coated on both sides with the non-stick material;
a biased member disposed within the handle and configured to bias the blade toward the thumb aperture; wherein the bias member is a strip of elastic material; wherein the bias member is coupled to an interior side portion of the handle and extends towards the thumb aperture; and
a cartridge disposed within the handle and configured to store a plurality of blades including a safety lock mechanism; wherein the safety lock mechanism is disposed near a front end of the handle and configured to selectably lock a blade in a lateral position; wherein the cartridge is permanently coupled to the handle;
wherein the cartridge is selectably removable from the handle through the cartridge loading aperture; wherein the safety lock mechanism is configured to secure the cartridge within the handle; wherein the cartridge further includes:
a plurality of blades disposed within the cartridge;
a bias member coupled to the interior portion of the cartridge extending towards a thumb aperture;
a second thumb aperture through a side end of the cartridge and configured to allow a thumb to manipulate therethrough; and
a second blade feed aperture through a front end of the cartridge and configured to allow a blade to pass laterally therethrough.
